(19) United States
(12) Patent Application Publication
(10) Pub. No.: US 2005/0195978 A1
(43) Pub. Date: Sep. 8, 2005

(54) Method and apparatus for encoding and selective distribution of licensed digital content

(76) Inventors: Miodrag Babic, Las Vegas, NV (US); Brian K. Walker, Las Vegas, NV (US); Hridaynath Eknath Musale, Sunnyvale, CA (US)

Correspondence Address: WEIDE & MILLER, LTD., 7251 W. LAKE MEAD BLVD., SUITE 530, LAS VEGAS, NV, 89128, US

(21) Appl. No.: 10/794,328

(22) Filed: Mar. 4, 2004

(51) Int. Cl. H04K 1/00

(52) U.S. Cl. 380/231

(57) ABSTRACT

A method and apparatus for capture and distribution of audio and video media including digitalization, encryption and media management from live and archived audio and video sources. The method and apparatus utilizes a unified software application to employ digitalization, distribution, digital rights management, and encryption in real time based on digitalization, encryption and distribution rules. Use of a unified software application unifies numerous complex steps and insure proper interface between otherwise potentially incompatible software and hardware modules which are distributed at various remote locations. Capture and distribution of secure and validly purchased media may then be distributed to appropriate destinations for immediate use or storage subject to the rights granted by the digital rights management rules.

### FIELD OF THE INVENTION

The invention relates to computer software and associated systems and in particular to a method and apparatus providing a unified system for creation and distribution of encrypted, licensed digital content.

### RELATED ART

The Internet and personal computers have dramatically changed the way digital media content, such as music, films, and books, are produced, distributed and consumed. Streaming and downloading encoded files has gained acceptance among computer users because it provides immediate access to desired content and does not require a trip to a store or reliance on physical media, such as a CD or DVD. However, digital media content that is available for sale on the Internet is still limited, as content owners, artists, and publishers are concerned about protecting their copyrighted works from illegal use. As the market evolves and content owners explore new ways to enable different business models, more premium content will become available on the Internet.

Before owners of premium digital media content will offer their valuable content for sale or promotion, a secure e-commerce system that protects digital content from illegal use is needed. A component of any such e-commerce system is digital rights management (DRM). Absent such a system, digital content may be copied and resold without payment to or control by the copyright owner.

DRM is a technology content owners can use to protect their copyrights and stay in closer contact with their customers. In most instances, DRM is a system that encrypts digital media content and limits access to only those people who have acquired a proper license to play the content. That is, DRM is a technology that assists in the secure distribution, promotion, and sale of digital media content on the Internet.

Current encoding software and utilities such as Microsoft Windows Media Encoder are designed to acquire media content in form or video and audio from a wide range of capture cards where such video and audio content is processed by the capture card and handed to encoding software for encoding, video and audio compression into files designed to be viewed over the Internet in form of streaming or HTTP downloading using media player such as Microsoft Windows Media Player.

However, these prior art systems and options have numerous drawbacks. One such drawback is that if the media or content is not encrypted, media can be accessed by anyone who has a URL path to the media, Internet connection and media player such as Windows Media Player.

Another drawback is that a unified process to create, encode and/or encrypt, deliver and provide access to the content is simply not available. Absent such a process or system, protected content may not be provided. The method and apparatus described below overcomes the drawbacks of the prior art.

### SUMMARY

In one embodiment, a method is disclosed for providing digital content to a remote location comprising generating content from a performance and then assigning distribution rules to the content to generate a package. The package may have a package description describing the content and at least one rule. This method then sends a request to a digital rights management server for the encryption scheme and encodes the content wherein the encoding comprises encrypting the content. The encrypted content is transmitted for storage on a first server while the method provides an access point to the encrypted content on a second server. In one embodiment the second server provides the package description and a content purchase option. To obtain the content, the method may be configured to obtain proof of payment at the second server and thereafter, request a license from a digital rights management server such that the license allows for decryption of the encoded content at the remote location. It is further contemplated that the method may also involve sending the encrypted content to the remote location.

In one embodiment the license key is utilized in an encryption or decryption process. It is also contemplated that the performance may be pre-recorded. The proof of payment may be a prerequisite to obtaining a license from a digital rights management server. The method may further comprise the step of establishing one or more rules for the package that govern use of the package.

Also disclosed herein is a method for establishing digital content for download, live and on-demand streaming delivery. This method maybe divided into three steps. The first comprises establishing one or more media digitization settings and obtaining one or more encryption keys from a media management database. The first step then identifies content which may be encrypted upon initiation of encoding.

During a second step, the method encrypts the content based on the one or more encryption keys and optionally updates a status indicator. Finally during a third step the method ceases encryption of the content and updates the status indictor.

In one or more various embodiments the second step further comprises disabling use of a refresh option. It is contemplated that this method may archive the encrypted content to a storage media. The first step may further comprise posting a key identification to the media management database and the method may be controlled from a single software application.

Also disclosed herein is a computer program product comprising a computer usable media having computer program logic recorded thereon for establishing, encoding, and distributing digital content. In such an embodiment computer program code logic configured to accept digital content from a content source and further configured to exchange an encryption key with a digital rights management server. Additional computer program code logic is configured to encode and encrypt the digital content based on the encryption key to create encoded and encrypted content while other computer program code logic is configured to provide the encoded content to a streaming server and store content onto media storage. Also part of this system is computer program code logic configured to manage the access to media at a content offering server wherein the content offering server provides access to obtain a license to the encoded content.

In one embodiment the source comprises a signal from a performance or a stored performance. Further, the DRM encryption scheme may be exchanged between encoder and DRM server. In one configuration, digital rights management server, the streaming server and the content offering server are located at the same or different locations and communicate via the Internet. The computer program product may also create a package, wherein the package comprises one or more encoded contents.

An additional method disclosed herein comprises a method for establishing a connection with a DRM server and generating encryption information. This method comprises access security settings within an encoder and establishing a network location for a DRM server thereby allowing the encoder to obtain a DRM encryption keys. The method then creates or selects a DRM profile which in one embodiment comprises the steps of sending from the DRM server at least one of a private key, public certificate, license certificate, root certificate, and seed to the encoder software and sending from the encoder to the DRM server at least one of a public key, seed and DRM profile. The method then applies the DRM profile such that the encoder utilizes the DRM profile for media encryption and thereafter sends a key ID from the encoder to the database, wherein the key ID may be used by DRM server to deliver a license that will unlock the encrypted media created with the encoder.

In one or more variations, the encoder is embodied in machine readable code and when the encoder starts encoding, video and audio is converted to compressed encrypted media. It is further contemplated that the encoder may be configured to control media access to allow access to media once the media is ready for distribution and all encryption scheme information is available to the DRM servers.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a block diagram of an example environment of use and exemplary system utilized or accessed during use of the method and apparatus disclosed herein.

FIG. 2 illustrates a block diagram of an example embodiment of a license delivery and content distribution system.

FIG. 3 illustrates a block diagram of an example embodiment of the ISP Software Package to media management interface and media management database.

FIG. 4 illustrates a block diagram of an example embodiment of a DRM Media Management System.

FIG. 5 illustrates a block diagram of an example embodiment of the ISP secured media distribution system.

FIG. 6 illustrates an operational flow diagram of an example method of a first click initialization process.

FIG. 7 illustrates an operational flow diagram of an example method of a second click start encoding process.

FIG. 8 illustrates an operational flow diagram of an example method of a third click stop encoding operation.

FIG. 9 illustrates an operational flow diagram of an example method of package creation.

FIGS. 10-20 illustrate exemplary screen displays of an example embodiment of the ISP system as described herein.

### DETAILED DESCRIPTION

To overcome the drawbacks of the prior art, the method and apparatus described herein provides a complete and unified system for content encryption, license issuance, distribution and playback of digital content. The method and apparatus described herein is available from iStreamPlanet, Co. located in Las Vegas, Nev. and as such term ‘ISP’ as used herein refers to one or more components, software, processes, system or methods invented or assembled by iStreamPlanet, Co.

In general, an end-to-end secured media distribution system over the Internet consists of: (1) media acquisition and digitalization; (2) media encryption; (3) secured media delivery based on business rules that govern content distribution via live streaming, on-demand streaming or downloading; and (4) license delivery and managed media access and playback. Media encryption may be performed using digital rights management (DRM) encryption scheme that encrypts the media and requires a license to unlock the media so media can be played with the media player.

Streaming media technology enables the real time or on demand distribution of audio, video and multimedia on the Internet. Streaming media may be considered as the simultaneous transfer of digital media (video, voice and data) so that it is received as a continuous real-time stream. Streamed data may be transmitted by a server application and received and displayed in real-time by client applications. These applications can start displaying video or playing back audio as soon as enough data has been received and stored in the receiving station's buffer. A streamed file is simultaneously downloaded and viewed, but leaves behind no physical file on the viewer's machine while downloading leaves a file on the viewer's machine and can but it does not need to be viewed at the time of download. The term machine as used herein is defined to mean any device, computer, or system capable of or configured to receive streamed data for presentation to a viewer, listener or both.

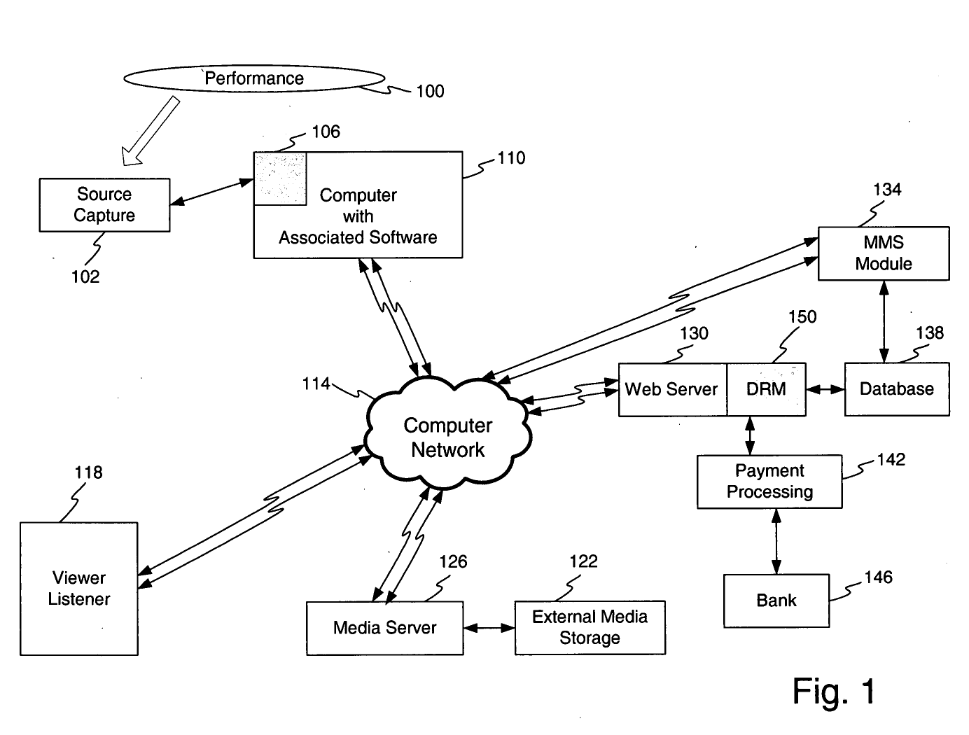

FIG. 1 illustrates a block diagram of an example environment of use and exemplary system utilized or accessed during use of the method and apparatus disclosed herein. It is contemplated the ISP system and method as described herein may operate in other exemplary environments. As shown in this example embodiment, the performance 100 may comprise any type event such as any concert or competition or performance, or may comprise a prerecorded event, such as a previously digitized performance. A source capture device 102 such as the camera, microphone, or electrical connection captures the performance. It is contemplated that there may be more than one capture device 102. The capture device 102 provides the electrical or optical signal representing the performance 100 to an interface card 106 configured to be compatible with a computer with associated software 110. The interface card 106 may comprise a video or audio processing device and may include one or more analog to digital converters as is understood by one of ordinary skill in the art. The computer 110 may comprise any type computer capable of performing the functions and executing software as described herein. It is contemplated that in one embodiment the ISP Software Package that is configured to provide the method and apparatus described herein may operate and reside on the computer 110. The functionality of the ISP Software Package is described below in more detail.

The computer 110 interfaces or otherwise connects to a computer network 114 configured to transfer digital data between one or more remote locations. In one embodiment the computer network 114 comprises the Internet as is understood by one of ordinary skill in the art. Also connected to the computer network 114 is a viewer or listener 118, which also may be referred to herein as an end-user. It is contemplated that the end-user 118 is desirous of viewing or listening to or otherwise obtaining access to the performance 100. However, to facilitate such transfer of digital content it may be desired by the copyright owner of the performance to obtain payment from the end-user 118 and ensure protection of the digital content provided to the end-user.

To facilitate this transaction of digital content, an operator utilizing the computer 110 establishes a connection with media server 126 and secure connection with MMS Module 134 to thereby oversee control and access to the content. In one embodiment the content is stored on external media storage 122 which may be accessed via media server 126. As is understood an end-user 118 may utilize the computer network 114 such as with a web browser too gain access to the content via the media server 126 and external media storage 122. The content may be streamed from the media storage 122 by using the media server or directly downloaded.

As part of this process an operator at the computer 110 may establish an event or package which may be accessed at a remote web server 130. As described below in more detail the operator provides information regarding the event or package via MMS Module 134 to the database 138, which the end-user 118 may access to selectively purchase or obtain access to the content via remote web server 130.

Associated with the server 130 is Media Management System (MMS Module) 134 which may be used to create and modify events and assign media to the events, create and modify business scenarios for media delivery and package events as a standalone single event or combination of events for the playback by end-users and to facilitate exchange of DRM encryption information. The web server 130 also communicates with a database 138. The database 138 is configured to store all information about the content that can be updated in real-time by the operator on computer 110 or by using MMS Module 134. The term content is defined to mean the digital information, such as video, audio, or both, provided to an end-user. In this embodiment the database is used to store event information, package information, customer information and all DRM information that is used to encrypt the content and generate licenses. It is contemplated that the media may be stored on the media storage, such as a server, NAS (network attached storage) or SAN (storage area network). Also associated with the web server 130 is a payment processing unit 142 which may be in communication with a bank or financial institution 146. Processing of payments via online credit card or debit card or check transactions is generally understood in the art and as such is not described in detail herein. It is contemplated, however, that the end-user 118 may request access via web server to an event established by an operator at computer 110 and as part of the obtaining or granting access, the end-user may provide payment which is verified utilizing payment processing unit 142 and bank 146 and/or financial institution. Further, associated with the web server 130 is digital rights manager 150. In one embodiment the digital rights manager 150 can be installed on a web server 130 and called directly to issue licenses. It is also contemplated that the digital rights manager may be called or accessed from or on a different server.

Upon proof of payment for access to content established by a user at the computer 110 the web server or other software component generates a request to a digital rights manager 150 to generate and grant a digital rights management license to the end-user 118. In one embodiment this occurs by passing the license information for that particular piece of content from the database 138 to the digital rights manager 150. The transfer of a license to an end-user 118 may occur when end-user 118 clicks on the content link to access the content. It is contemplated that the license may comprise a code or other password which may or may not be known to the end-user.

After granting of a license by the digital rights manager 150 the end-user 118 is able to access the content stored on the external media storage 122 via media server 126 or live content delivered directly via media server 126. It is contemplated that the data on the external media storage 122 may be published worldwide via one or more media servers 126, only one of which is shown in FIG. 1. It is further contemplated that the computer 110 may interface with the digital rights manager 150 upon establishment of the event at the MMS Module 134 to thereby establish encryption of the digital content which may be unlocked or decoded i.e. unencrypted upon use of the license granted by the digital rights manager 150 and web server 130. It should be noted that this is but one possible implementation an example environment of use for the method and apparatus described herein and as such the claims that follow should not be considered as being limited to the environment shown in FIG. 1.

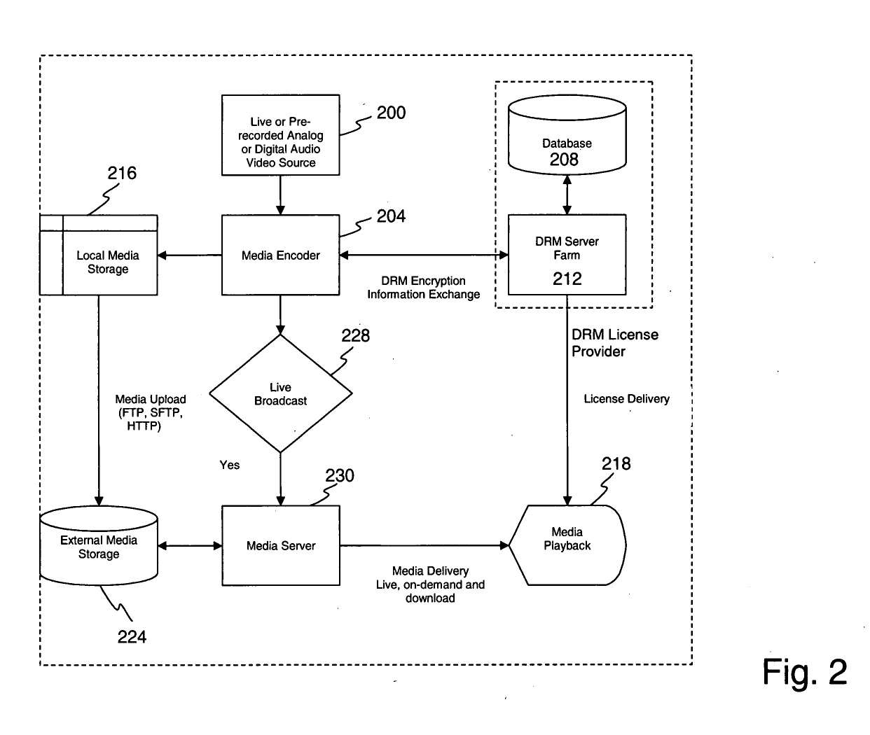

FIG. 2 illustrates a block diagram of an example embodiment of a license and content distribution system. As shown in FIG. 2 a content source 200 which may comprise live or prerecorded analog or digital information, provides a signal representing the performance or audio or video source, to a media encoder 204 configured to process the signal in accordance with the method and apparatus described herein. In one embodiment this comprises encryption of the signal. As part of the encryption it is contemplated that communication and exchange of information may occur which may involve a DRM encryption information exchange operation between one or more servers, such as, for example, a server farm 212 which is in communication with a database 208. The encryption information exchange operation provided to the media encoder 204 may be incorporated with the encryption process of the content from the source 200. It is contemplated that the DRM license provider may also deliver a license to an end-user via DRM server to facilitate media playback 218.

The media encoder may optionally provide the encrypted content for storage at a storage location 216 which may turn forward to content to external media storage 224. Alternatively the media encoder 204 may output the content for live streaming broadcast 228. This content may be routed to the media playback device 218 via media server 230 and thus, in this manner the delivery may occur on a live, on-demand, or download basis.

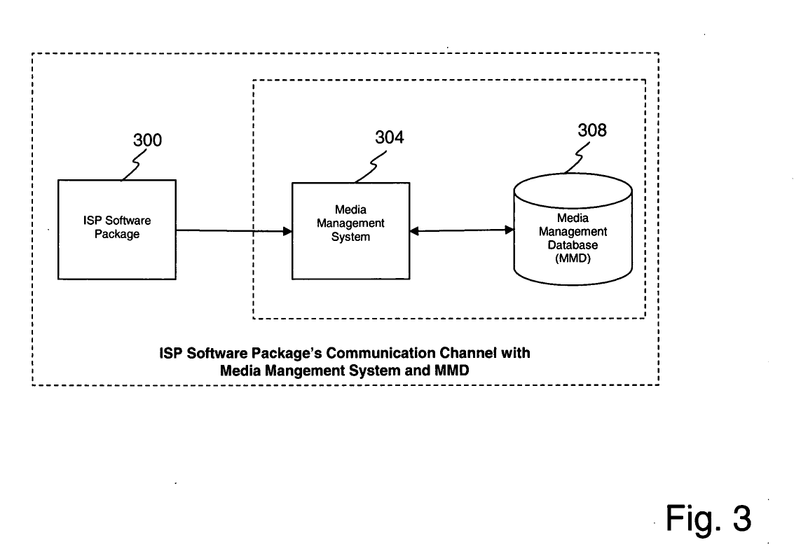

FIG. 3 illustrates a block diagram of an example embodiment of the ISP Software Package communication with the media management interface. This is but one possible interface and as such one of ordinary skill in the art may arrive at other interface configurations and methods of operation which do not depart from the claims that follow. It is contemplated that the ISP Software Package 300 has a web-based access to Media Management System 304 and has ability to update Media Management Database (MMD) 308 via Media Management System 304. It is contemplated that the Media Management System 304 may access or communicate with the MMD 308. In operation, these elements, 300, 304, and 308 give an operator of the ISP Software Package ability to manage secured media distribution process in real-time.

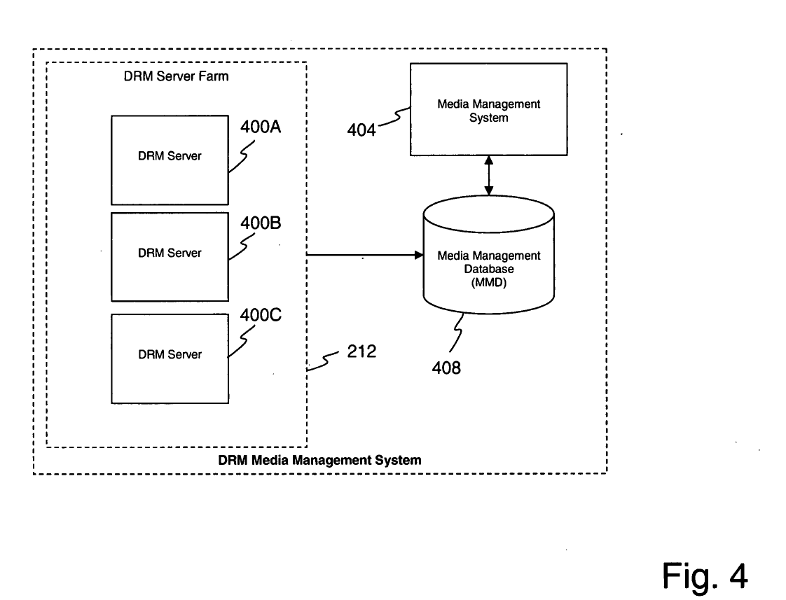

FIG. 4 illustrates a block diagram of an example embodiment of the DRM Media Management System. One of ordinary skill in the art may arrive at other embodiments without departing from the scope of the invention. The DRM system shown in FIG. 4 may be similar to elements 208 and 212 in FIG. 2. In this example embodiment, a DRM server farm 212 comprises one or more servers 400A, 400B, 400C which are load balanced to be able to handle potentially infinite number of end-users requesting licenses. The servers may access a Media Management Database (MMD) 408 which stores some or all DRM information necessary to issue license dynamically. The database 408 may be populated and controlled by a Media Management System 404. In general, the DRM Media Management System integrates Media Management System 404, Media Management Database 408 and DRM Server Farm with ISP Software Package to create manageable secured media distribution system.

As an advantage over the prior art, the method and apparatus described and claimed herein may be presented in unified software package configured to seamlessly unify the numerous complex and required steps under control of a single software package and implement the process in the proper order and only after completion of the proper steps as embodied herein. Absent the method and apparatus described herein it would not be possible to synchronize operation of the various activities to achieve content encryption, and license delivery in a manner that would allow access by an end-user.

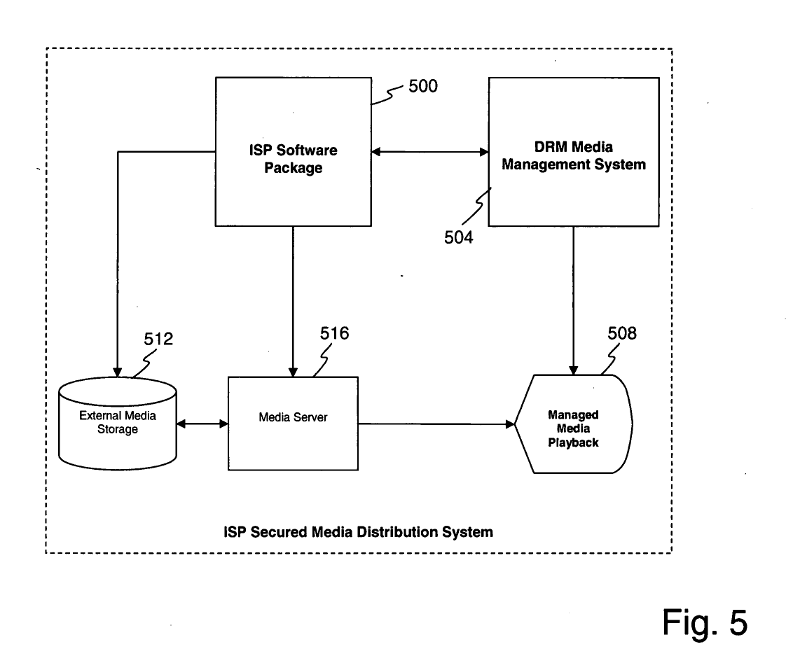

FIG. 5 illustrates a block diagram of an example embodiment of the ISP secured media distribution system. This is but one possible example embodiment of a secured media distribution system. In general, in this example embodiment, the ISP Software Package and DRM Media Management System are configured to perform all four steps of secured media delivery process (1) media acquisition and digitalization; (2) media encryption; (3) secured media delivery based on business rules that govern content distribution via live streaming, on-demand streaming or downloading; and (4) license delivery and managed media access and playback.

In this embodiment an ISP Software Package 500 processes data to generate encrypted, license accessible content having one or more rules associated therewith, that govern use or other aspects, associated therewith. As part of the processing, referred to herein as encoding, the encoder 500 interfaces or communicates with the DRM Media Management System 504. In one embodiment the management system 504 generates and provides the DRM encryption schema information to the encoder 500. In another embodiment the DRM encryption schema information may be generated at or by a device or system other than the management system 504. In one embodiment the DRM encryption schema comprises of private key, public certificate, license certificate, root certificate, public key and seed. The encoder 500 may be configured to output the content to external media storage for use in other than streaming media environment, or provide streaming media directly to a media server 516. The media server 516 comprises a connection location to which an end-user may connect to obtain the content. In one embodiment a managed media playback device 508 connects to the media server to obtain either the content as streaming data, such as for real time viewing, or from the media 512, as a download or on-demand. It is contemplated that the streaming data may also be stored by the end-user for future use.

In one embodiment the encoding process consists of multiple steps including: (1) setting capture device, (2) video and audio source selection, (3) selecting broadcast or encoding type that can be live broadcast, capture to a file, file conversion or screen capture, (4) providing live broadcast settings including server media acquisition method that can be: (a) pulled where streaming media server or group of servers initiate connection with the encoder via encoder's IP address and port used to broadcast media, or (b) pushed where encoder pushes content to the streaming media server via IP address and publishing point, (5) selecting encoding profile that consist of bit rate, frame rate and buffer size settings, (6) selecting if encoded audio and video will be archived and if so, at what location should archived file be stored, (7) information about the media that can but doesn't have to be displayed during the playback of the media and includes title, author, copyright, rating and description information. Of course, these are the steps that occur as part of the media acquisition and digitalization. As can be appreciated, these are a summary of the steps and as such, each step comprises numerous sub-steps and other steps may be listed.

As an advantage of the method and apparatus claimed herein, the numerous processes are not only configured to provide for distribution of secure content based on license rights, but the oversight and control of these numerous complex and confusing processes may be unified and synchronized with a unified software package configured to run from a single location yet access and control network elements at a variety of remote locations.

It is further contemplated that there are at least four different ways a license can be delivered to the end-user: (1) non-silent where end-user is prompted to do something; (2) silent where there is no end-user interaction required; (3) non-pre-delivered where license is acquired separately and after media has been acquired; (4) pre-delivered where license is acquired before or at the time media is acquired. By way of example, when using Windows Media Encoder, media encryption requires integration with DRM server which is the server responsible for generating encryption scheme elements and generating and delivering the license that will unlock encrypted media. A purpose of integration between Windows Media Encoder and DRM server is to exchange encryption scheme information and to create a DRM Profile that contains all encryption scheme information and it is used by the Encoder to encrypt the media.

In one embodiment to establish the connection with DRM license provider's DRM server and to generate all encryption scheme information, an encoder operator needs to go through the following steps: (1) inside Windows Media Encoder Properties option operator needs to access Security tab; (2) DRM license sever provider who hosts DRM servers needs to be added to the list along with the URL that connects encoder to provider's DRM server; (3) this is where DRM profile creation takes place and it consists of: (a) DRM server passes private key, public certificate, license certificate, root certificate and a seed to the Encoder; (b) upon reception, Encoder passes back to DRM server a public key, seed and DRM profile created; (4) encoder operator needs to select created DRM profile and apply the selected profile so Encoder uses selected profile for media encryption; (5) once DRM profile is applied, encoder returns the Key ID; (5) to complete the process, Encoder operator needs to pass back the Key ID to the DRM license server provider so license server provider can pre-deliver license that will unlock the encrypted media created with the Encoder. Once Encoder operator starts the process of encoding, video and audio will be converted to compressed encrypted media. This concludes step 2.

Currently steps 3 and 4 are not integrated with Windows Media Encoder or any other encoding software and there are no solutions on the market that give an encoder operator the ability to control media access so users access media once media is ready for distribution and all encryption scheme information is available to DRM license sever provider and license that unlocks the media can be created and issued to authorized end-users. In the prior art an encoder operator may perform media acquisition, digitalization and encryption as described above without having direct communication with DRM license provider and front-end system such as website that pre-delivers the license to the end-user and grants the access to the media. As a result the end-user is often unable to play the media because: (1) end-user gets the invalid license to the media which was created with an incorrect Key ID because an encoder operator has not passed the updated Key ID back to DRM license provider; (2) end-user gets access to media URL before media has been created; (3) if media is to be accessed via on-demand streaming or downloading, media file needs to be placed on a server, media storage or any other file handling mechanism that serves media files. Typically media is transferred to such device via file transfer protocol (FTP) or secure file transfer protocol (SFTP) however there are other methods such as HTTP upload or copying files directly from encoder file system to file handling mechanism. If media is not placed or a URL path to the media is not created and passed on to the end-user, end-user will not be able to play the media.

Thus, as can be appreciated, the importance of passing back Key ID and pre-delivery license model should not be discounted. When using pre-delivery as a license delivery method, operator or media encryption system is able to encrypt media only once and retains ability to create different licenses with different business rules and issue them to multiple end-users. When using other license delivery methods such as silent delivery, operator or media encryption system can encrypt media for each end-user and needs to embed content ID and/or some other piece of information that can be used to authenticate end-user so media can only be played by authorized end-user.

As an advantage over prior art systems, ISP Software Package with DRM Media Management System was designed to address all four components of secured media distribution system. It fully integrates: media acquisition, digitalization, event provisioning and media assignment to the event, digital rights management and encryption process, media delivery to media servers and media storage so media can be delivered to the end-user according to business rules associated with the media delivery, license delivery and access to all three types of media delivery, live, on-demand and download.

For purposes of understanding and discussion, functionality of ISP Software Package can be divided in three feature groups: (1) Manager; (2) Encoder; and (3) Administrator. As noted, these categories are generated for purposes of understanding and as such, the claims that follow should not be interpreted as being limited to these enumerated groups.

Manager

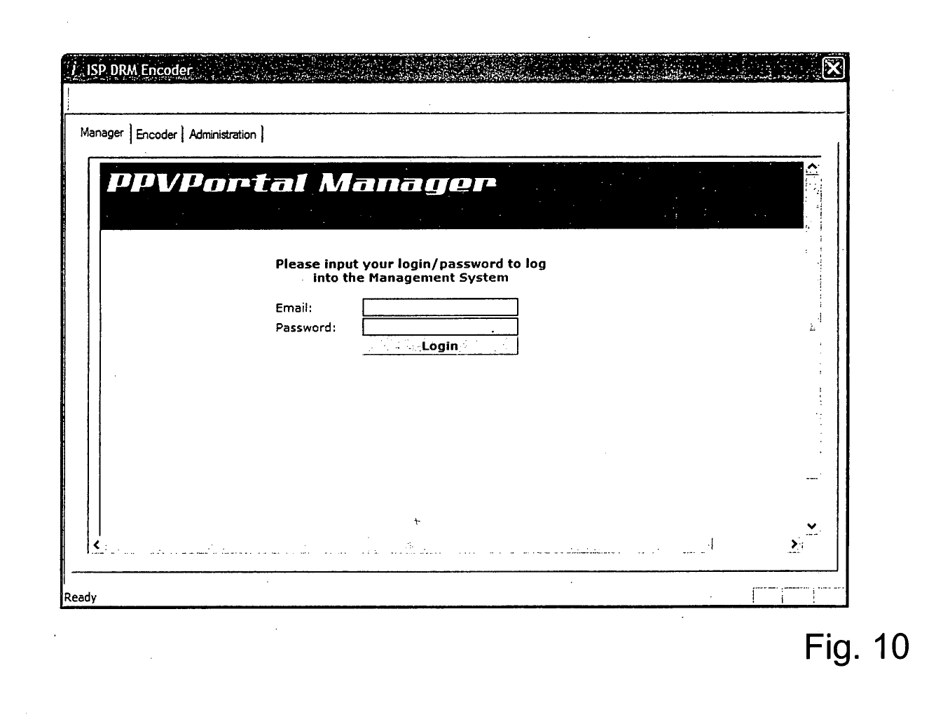

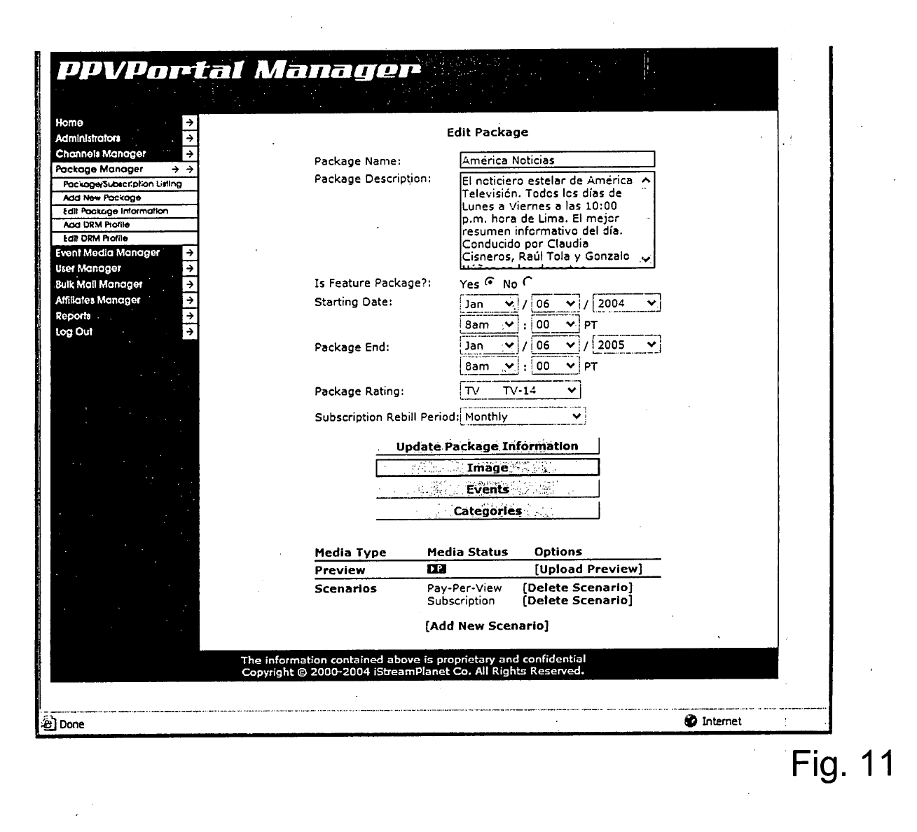

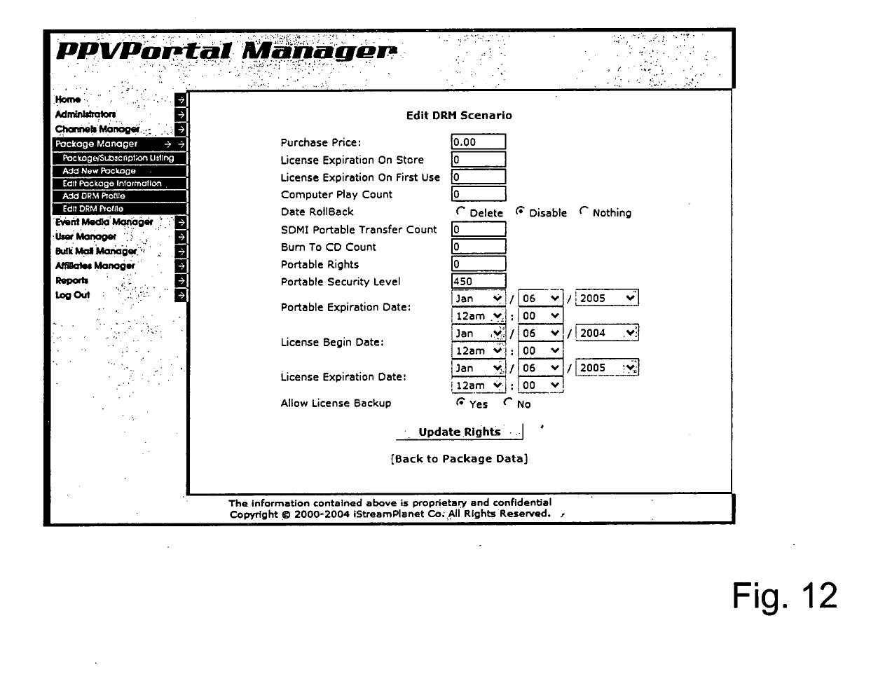

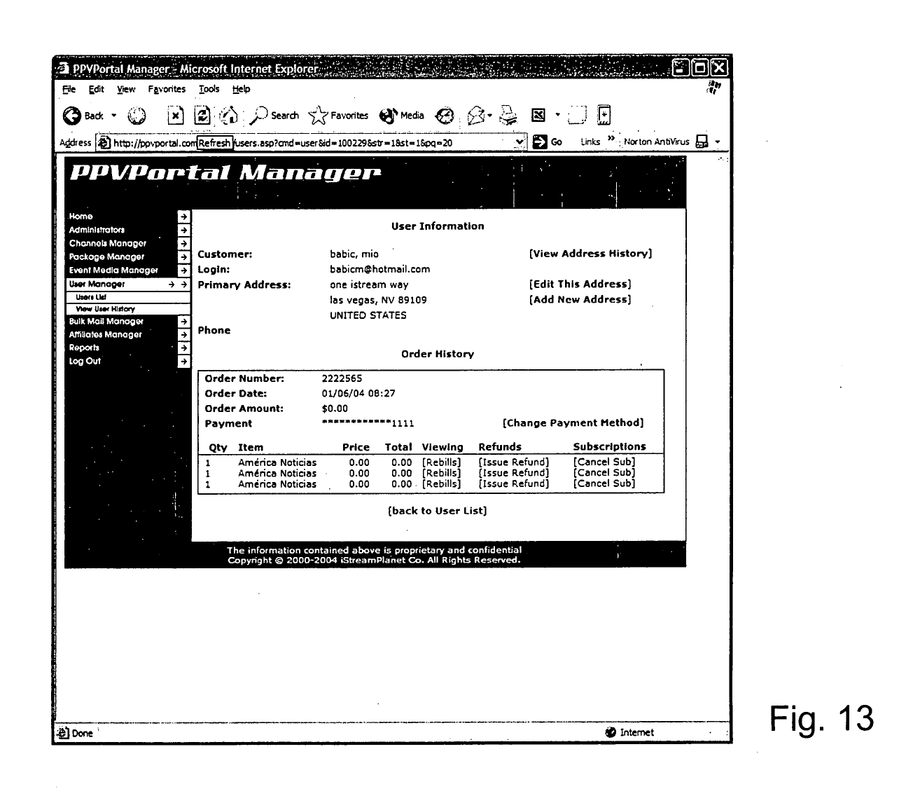

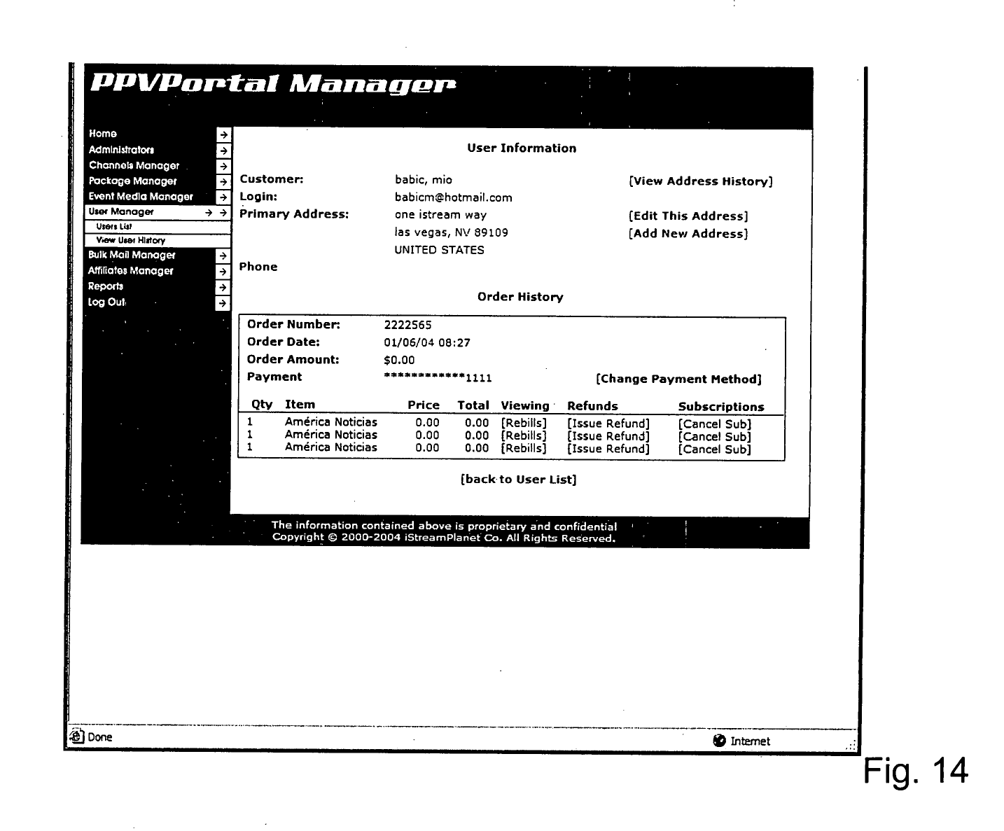

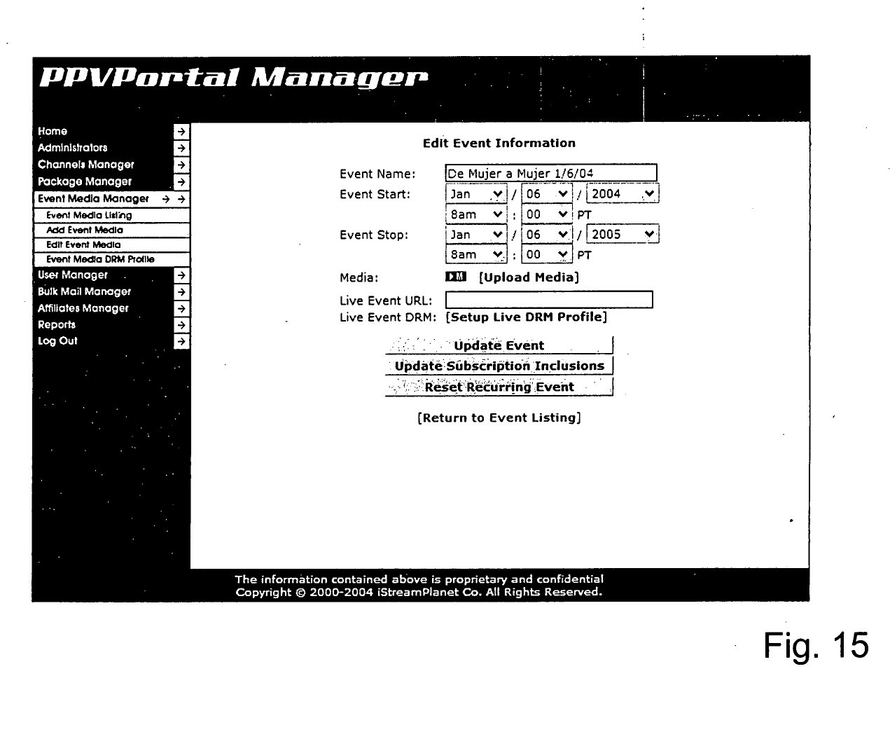

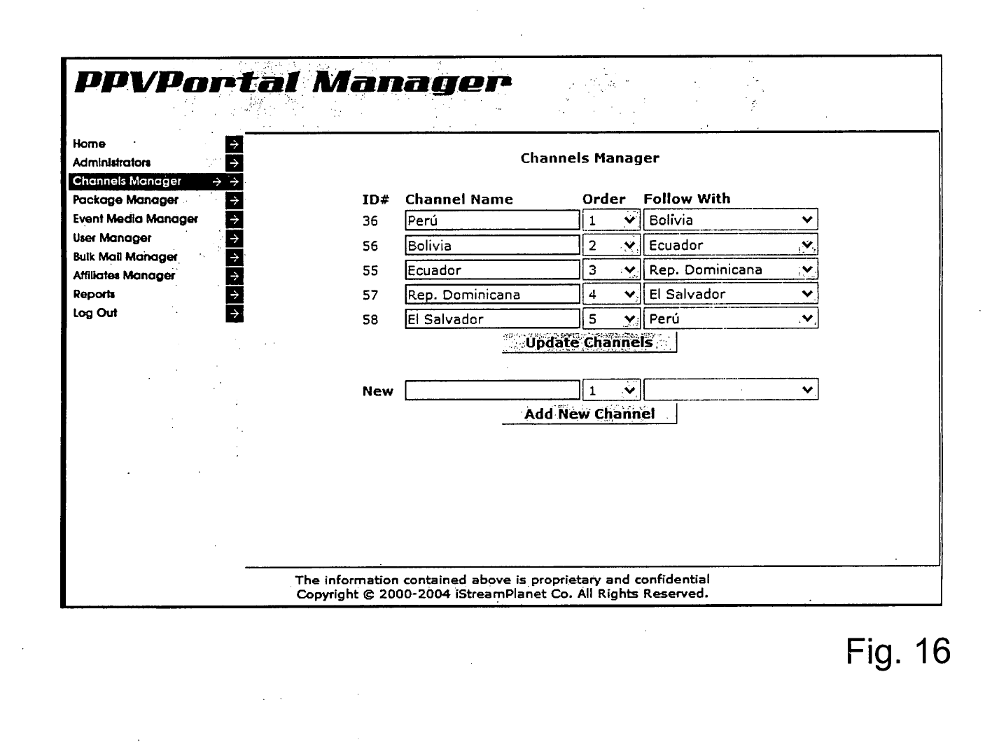

The Manager provides integrated web access to Media Management System. FIGS. 10-16 provide example screen shots of one example embodiment of the Manager screen.

Media may be delivered to the end-user according to business scenarios created, and scenarios are: (a) live; (b) on-demand; (c) download; or (d) subscription which can be live, on-demand, download or combination. Live, on-demand and download are considered one time events while subscription is created from recurring events, collection of recurring events, or event or collection of new events where end-user gets access to subscription media in exchange for recurring monthly, weekly or annual monetary fee.

The Manager may be designed as a Web browser embedded into ISP Software Package with browser capabilities that allow operator to navigate through the Media Management System. Operator can choose to use ISP Software Package to access Media Management System or a standard Internet browser such as Microsoft Internet Explorer browser. All information about the events including event title, event description, start time, end time, business scenarios, digital rights management encryption scheme elements including private key, public key, public certificate, license certificate, root certificate and content ID and event status may be stored in Media Management Database (MMD). Event status is a number value that indicates stage of digitalization and encryption process. For example, 0 indicates that event exists and it's ready to be digitalized and encrypted, 1 indicates that event media is in the process of digitalization and encryption, 2 indicates that digitalization and encryption has been completed and 3 indicates that created media has been uploaded to media storage for on-demand playback or downloading. In other embodiments other designators may be used.

In the example embodiment shown herein, the Manager and thus the Media Management System, is enabled with eight main features. These features of the Manager are: Administrators, Channels Manager, Package Manager, Event Media Manager, User Manager, Bulk Mail Manager, Affiliates Manager and Reports. Further explanation of the Event Manager's main features is now provided.

Administrators feature enables the operator to create access and user rights for other operators using the Manager. For example, an operator might want to add operators with full administrator rights but you also might want to add operator that has only rights to access media and packages but not other features. Access can be granted or denied to any of the eight features of the Manager.

The Channels Manager feature enables an operator to create and modify channels or ‘categories’ and assign packaged media to those channels. Channels may be dynamically displayed to the end-user and end-user can locate and navigate through channels to find packaged media with common subjects. For example, if looking for Rock music, you would click on Rock channel to locate all Rock music available using the ISP system.

The Package Manager feature enables an operator to package created events on a standalone basis or as a collection of events, set purchase price, assign a preview so end-users can preview the package before the purchase, provide package description, start and end date, rating, assign graphical display for the package (image or flash file), create distribution scenarios and assign desired media access rights by defining the media license rights and create subscriptions. By way of example, if an operator has three soccer games, game A, game B and game C. With packaging system the operator can sell any of the games individually or the operator can combine them and sell them as certain combinations. For example, to sell all three games together a user may create a package, named Watch games A, B and C, provide a brief description of the games, assign rating to it, upload image showing some interesting moment from the game, upload a 60 second preview. Thereafter this package may be sold live and on-demand. An operator can create a live scenario, assign a price that would be charged to end-users to buy it, and put media access rules such as: license expiration on store, license expiration on first use, play count or number of times end-user can play the media, what happens if end-user rolls date back on their computer, number of times end-user can transfer media to a portable device, number of times media can be burnt to a CD, type of rights end-user has once media is transferred to portable device, security level, license expiration date for portable devices, license begin date, license expiration date and if user is allowed to back up license or not. These are all features that could be assigned to media to control access rights.

The Event Media Manager enables an operator to add and modify events, set titles, start and end dates and reset expired events. The User Manager enables an operator to manager all end-users on the system. Once end-user buys content he or she may be registered in MMD and all information such as name, address, payment type, credit card number or bank account number, packages purchased is also stored in MMD so that an operator can manage their end-users in real time. An operator can view all users, go to a detail mode to determine what package is being bought by the end-user, if content of the package has been viewed or not, issue refund on a purchase, reset viewing, modify address or payment type or cancel subscription if end-user has subscribed to subscription package.

The Bulk Mail Manager enables an operator to create email campaigns that promote new, upcoming or existing packages/events and market them to opt-in end-users. When end-user purchases, packages, and creates an account using the ISP system the method and apparatus allows them to tell us if they want to receive emails and in what format and that information is used to determine if end-user should receive email or not.

The Affiliates Manager enables an operator to add affiliates, other websites that can link their websites to operator's portal and track number of end-users coming from the affiliate's site to and operator's portal and track their purchases. Using the affiliates manager the operator can assign a commission or percentage of a sale that an operator wants to credit to an affiliate for sending end-user to the portal to make a purchase.

The Reports section or manager enables an operator to view different reports such as total amount of revenue generated per month and when purchases were made, number of packages sold and total revenue generated per package, number of subscribers per month and number of all users per month.

In addition, Manager has a standalone feature built in that may be totally transparent and fully automated but plays an important role for subscription based mode. It is a recurring billing system that automatically checks MMD every day for subscribers that need to be re-billed for next subscription period, re-bills them and sends report to operator.

Encoder

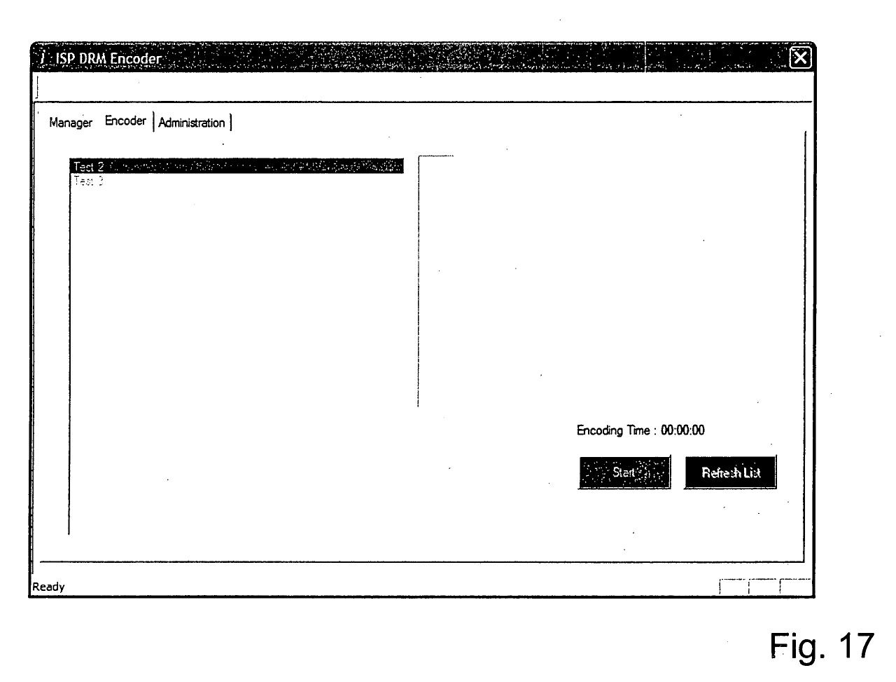

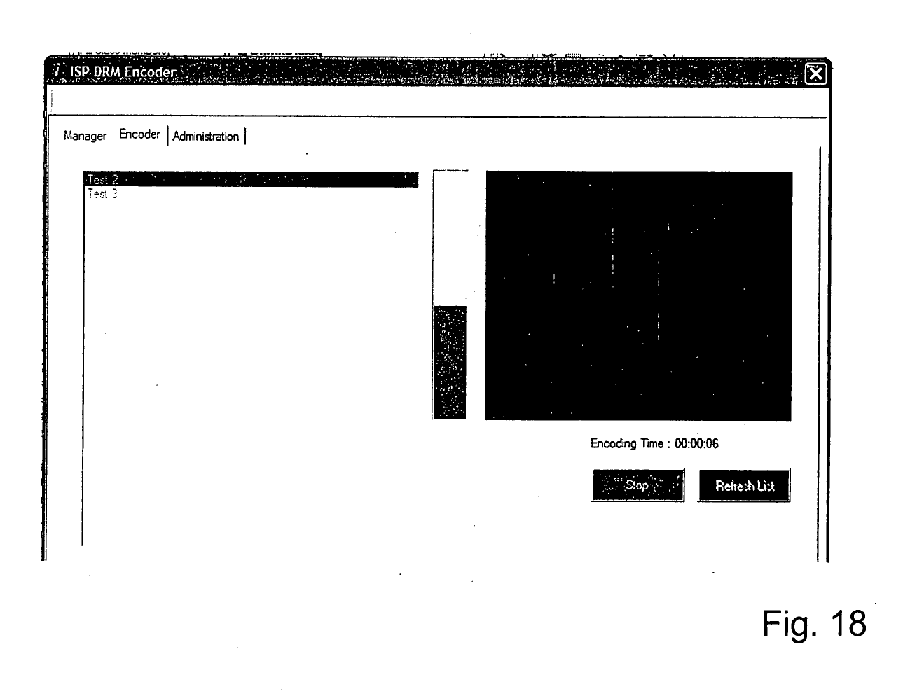

A discussion is now provided with regard to the Encoder component or feature. FIG. 17 and FIG. 18 provide example screen shots of one example embodiment of the Encoder access screen. The Encoder component provides lists of all events stored in MMD and ready to be digitalized, encrypted and distributed, preview of the video media being digitalized and encrypted, audio volume level indicator, encoding time (duration of media digitalization and encryption process expressed in hours:minutes:seconds format) and two buttons: (1) First button is Start Encoding button that invokes media digitalization and encryption process and turns into Stop Encoding button once pressed to stop the media digitalization and encryption process and if pressed a second time, it turns back to Start Encoding button. In one embodiment the Start Encoding button can not be pressed unless the operator has selected the event to be digitalized and encrypted and the Stop Encoding button does not appear unless digitalization and encryption process is active; (2) Refresh List button enables operator to make request back to MMD to check if any of the new events have been added and await digitalization and encryption process. Once ISP Software Package is started it may automatically check with MMD if there are any events waiting to be digitalized. All data retrievals and data posts to the MMD may be conducted via HTTPS call to Media Management System using XML socket and dynamic web pages. HTTPS may be set to use 128 bit Secure Socket Layer (SSL) connection. An encrypted SSL connection requires all information sent between a client and a server to be encrypted by the sending software and decrypted by the receiving software, thus providing a high degree of confidentiality. Confidentiality is important for both parties to any private transaction. In addition, all data sent over an encrypted SSL connection may be protected with a mechanism for detecting tampering—that is, for automatically determining whether the data has been altered in transit.

In addition, all calls may be authenticated against the MMD to prevent unauthorized access using identification ID further described below. Further, a timer may be built into ISP Software Package that automatically checks with MMD for new events or changes to the existing events and updates the event list. In one embodiment the Encoder uses Microsoft Windows Media Encoder Software Developer Kit (SDK) to access features of Microsoft Windows Media Encoder. In one embodiment all ISP Software Package functions may be executed with a mouse click or with a touch if ISP Software Package is installed on a computer with a touch-screen monitor. In one embodiment a complete media digitalization and encryption process may be completed with three clicks. The three clicks, i.e. three major steps of operation are now described.

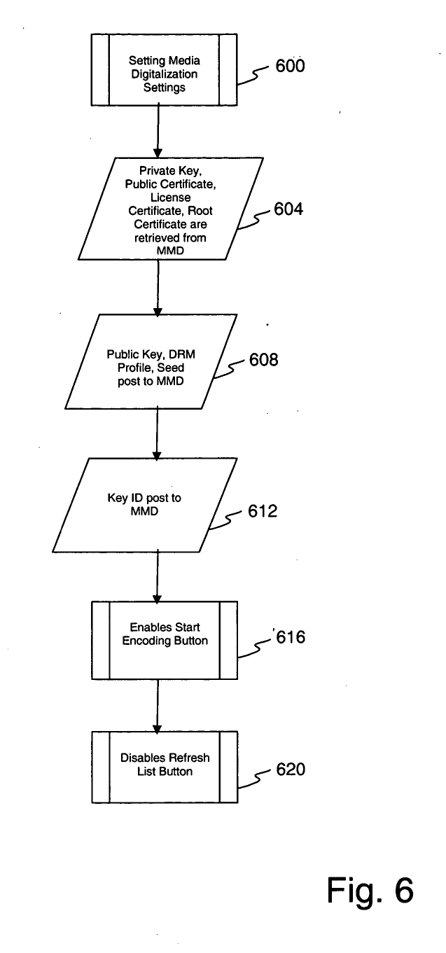

FIG. 6 illustrates an operational flow diagram of an example method of a first click initialization process. During a first click operation the Operator clicks on an event in the event list. This click invokes the following processes. At a step 600, the operator may set audio and video capture device, sets video source, sets audio source, sets broadcast or encoding type, sets live broadcast settings, and sets Windows Media Encoder to ready mode. During a step 604, the ISP Software Package may retrieve private key, public certificate, license certificate and root certificate from the MMD using Media Management System. At a step 608, the first click operation of the ISP system may post Public key, DRM Profile and seed to the MMD via HTTPS call to Media Management System using XML socket and dynamic web page.

Thereafter, at a step 612, the ISP Software Package generates the Key ID and posts it to the MMD via HTTPS call to Media Management System using XML socket and dynamic web page. And at step 616 the operation enables the Start Encoding button and at a step 620 disables the Refresh List button. This is but one example method of operation and as such, the claims that follow are not limited to this particular embodiment.

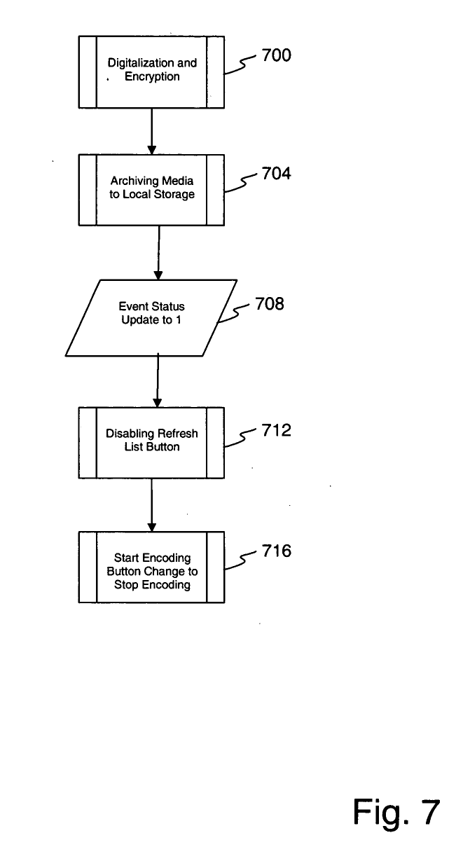

FIG. 7 illustrates an operational flow diagram of an example method of a second click encoding process. As part of the second click operation, an operator clicks on Start Encoding button. This invokes the following processes. At a step 700, the digitalization and encryption process is started. Then, at a step 704, the operation archives the created media. At a step 708, the Event Status is updated to status 1 in the MMD via HTTPS call to Media Management System using XML socket and dynamic web page. At a step 712, the disallowed application shutdown disables the Refresh List button. At step 716, the second click operation changes the Start Encoding button to Stop Encoding Button. This is but one example method of operation and as such, the claims that follow are not limited to this particular embodiment.

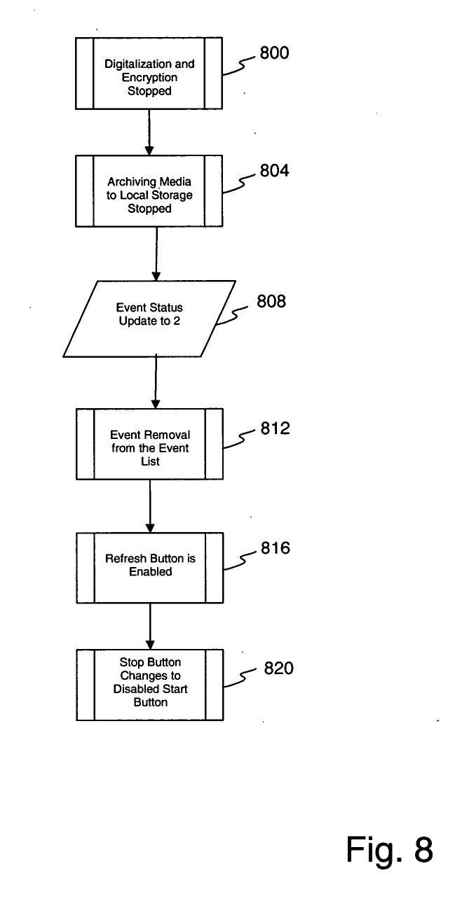

FIG. 8 illustrates an operational flow diagram of an example method of a third click stop encoding operation. The third click or (Click 3) operation may be initiated by an operator clicking on Stop Encoding button. This invokes the following processes. At a step 800, the digitalization and encryption process is stopped. At a step 804, the archiving media is stopped and then, at a step 808, the event status is updated to status 2 in the MMD via HTTPS call to Media Management System using XML socket and a dynamic web page. At a step 812, the event is removed from the list and, at a step 816, the system enables Refresh List button. Likewise, at a step 820, the system changes the Stop Encoding button to disable the Start Encoding button. Of course, this is but one example method of operation and as such, the claims that follow are not limited to this particular embodiment.

The process of uploading created media files for on-demand playback or downloading may also be fully automated. ISP Software Package has a built in timer that connects to MMD via HTTPS call to Media Management System using XML socket and dynamic web page and checks if there are any events with Event Status 2. If there are events with Event Status 2 and the ISP Software Package may be set to create on-demand and download media inside the Administration section, the ISP Software Package analyzes the created media by determining the media duration, creates FTP or SFTP session with the media storage and uploads the media file. Once a media file has been uploaded, the ISP Software Package may connect to the MMD via HTTPS call to Media Management System using XML socket and dynamic web page and updates the Event Status to status 3, writes event duration and URL paths to the media for on-demand streaming and downloading.

Further explanation of the Event Status and one embodiment of how it may be configured to provide a managed access to live, on-demand and download media is now provided. In one example method of operation, referred to herein as Case 1 an end-user is granted or has access or authorization to a live event but, if Event Status equals to 0, the end-user can not get access to the media URL path because: (a) a live event has not started yet; or (b) a proper license can not be issued because Key ID has not been passed back to the MMD. In this case, the end-user is notified that the live event has not started yet. Once Event Status is changed to 1, the end-user may be granted access to media URL path because live event is in progress and License Service Provider can issue a proper license because Key ID has been posted into MMD. Once Event Status is changed to 2, the end-user can not get access to media URL path because the live event has ended. In this case, the end-user may be notified that the live event has ended.

In an example situation referred to herein as Case 2, an end-user has access to live and on-demand event, then Case 1 stands, and in addition, once Event Status changes to status 3, meaning the media has been uploaded and URL path to media has been set, then the end-user is allowed access to media path for on-demand playback.

In an example situation referred to herein as Case 3, an end-user has access to on-demand event or media download. As a result, the end-user only gets access to media URL for on-demand playback or for the download once the Event Status is set to status 3, meaning the media has been uploaded to the storage and URL path to on-demand and download playback has been set.

Administrator

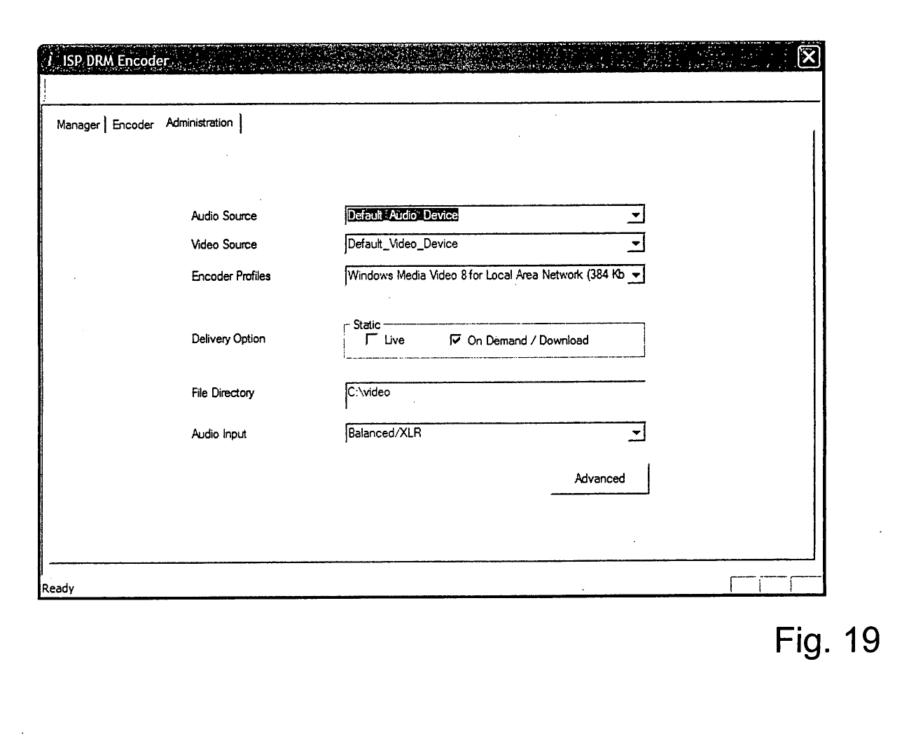

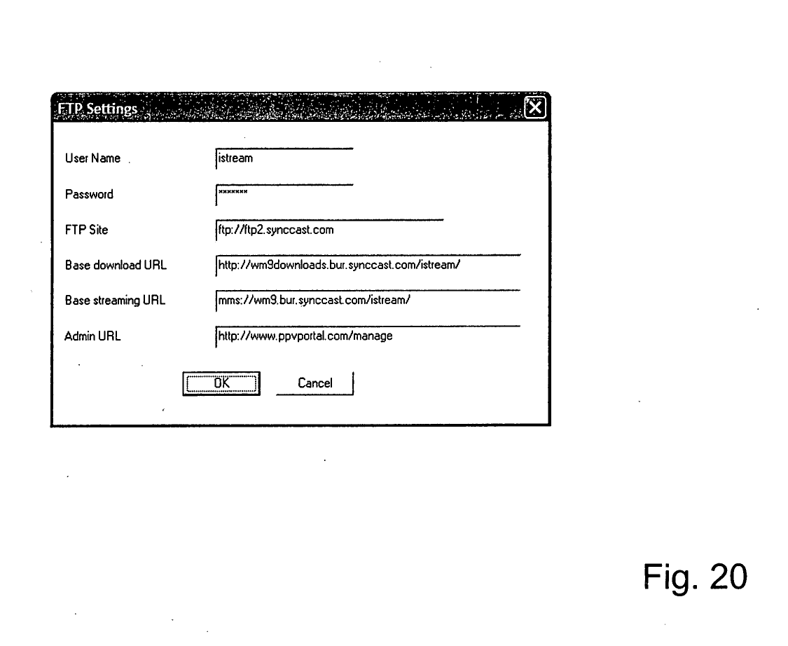

The ISP method and apparatus as described herein also comprises an administration section that enables an operator to modify multiple settings and functional elements of the ISP Software Package. FIGS. 19 and 20 provide example screen shots of one example embodiment of the Administrator section access screen. It may be designed to give an operator full flexibility to choose how: (a) ISP Software Package acquire video and audio signal; (b) what type of media delivery will be performed; (c) what file storage will be used; (d) what file uploading method will be used; (e) media archiving path on local machine; and (f) what encoding profile will be used. For example, video and audio can be acquired from any video and audio capturing device installed, including digital and analog signal processing devices. An operator can choose to deliver media live, on-demand, download or combination. In addition, an operator can choose any type of file storage capable of delivering media files by inputting base URL path to the storage for on-demand and download playback. ISP Software Package automatically adds media file name at the end of base URL and updates the MMD so URL paths to the media can be dynamically provided to the end-users. For example, an operator can choose file transfer protocol (FTP) or secure file transfer protocol (SFTP) by inputting FTP/SFTP settings such as URL path and username and password. The operator can choose where created media will be stored on the local machine and the operator can choose encoding profile among custom built collection of encoding profiles.

In addition, it is contemplated that all above listed updates/modifications are done without having to restart the ISP Software Package. Further it is contemplated that the features listed herein are provided by way of example and not limitation.

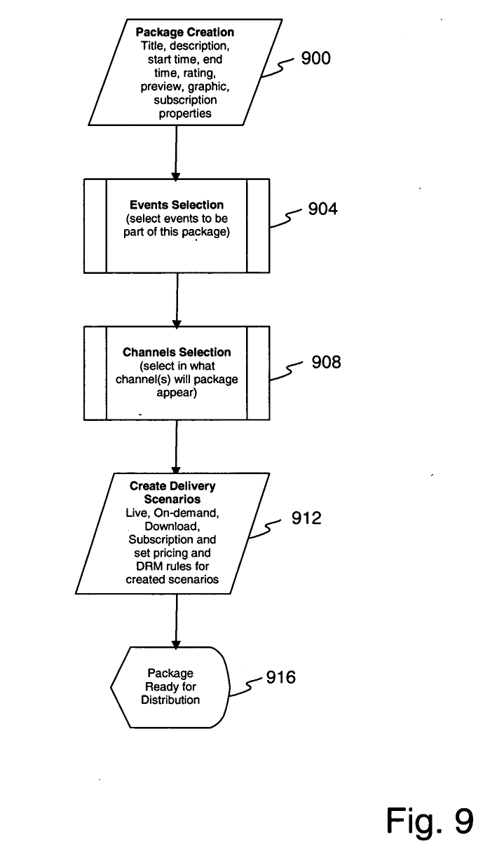

FIG. 9 illustrates an operational flow diagram of an example method of package creation. This is but one possible method of package creation and as such, the method and apparatus described herein should not be considered as being limited to this method of package creation. At a step 900, the package creation operation, such as may be performed by an operator, establishes a package title, description, start time, end time, rating, preview, graphic, subscription properties or any other attribute as may be contemplated by one of ordinary skill in the art. At a step 904, the method performs the event selection operation whereby the operator may select events to be part of the package. This may occur in any manner. At a step 908, the operator may select the channels. This may comprise selecting in which channels package will appear. Then at 912, the operator creates delivery scenarios. In one embodiment this comprises live delivery, on-demand delivery, download, subscription and pricing establishment, and establishing the DRM rules. Other actions may be taken in establishing the package. At a step 916, the package is ready for distribution.

As an advantage over prior art systems, ISP Software Package can be used by a virtually indefinite number of operators having access to, creating and delivering same or different media. During the installation process of ISP Software Package, an operator may be asked to provide a unique identification ID. This identification ID gets installed in the registry of the local computer hosting ISP Software Package and determines what events will be displayed in the Encoder Event List. Meaning, only events that belong to an operator identified by the identification ID will be displayed. The Identification ID may be authenticated against the MMD every time ISP Software Package makes updates or retrieves the data from MMD via an HTTPS call to Media Management System. The operator can use the Event Manager to add new events, modify existing events but can not display any other events other than those events authenticated by the identification ID unless, in one embodiment, the ISP Software Package is uninstalled and a new identification ID may be assigned.

While various embodiments of the invention have been described, it will be apparent to those of ordinary skill in the art that many more embodiments and implementations are possible that are within the scope of this invention. Further more, the elements and features described herein may be provided or enabled alone or in any combination.

1. A method for providing digital content to a remote location comprising:
generating content from a performance;
assigning rules to the content to generate a package, the package having a package description describing of the content and at least one rule;
sending a request to a digital rights management server for the encryption schema;
encoding the content wherein the encoding comprises encrypting the content;
transmitting the encrypted content for storage on a first server;
providing an access point to the encrypted content on a second server, the second server providing the package description and a content purchase option;
obtaining proof of payment at the second server;
requesting a license from a digital rights management server, wherein the license allows for decryption of the encoded content at the remote location; and
sending the encrypted content to the remote location.

2. The method of claim 1, wherein the license key is utilized in an encryption or decryption process.

3. The method of claim 1, wherein the performance is pre-recorded.

4. The method of claim 1, wherein the proof of payment is a prerequisite to obtaining a license from a digital rights management server.

5. The method of claim 1, further comprising establishing one or more rules for the package that govern use of the package.

6. A method for establishing digital content for one or more of download, live steaming delivery, or on demand comprising:
a first step comprising:
establishing one or more media digitization settings;
obtaining one or more encryption keys from a media management database;
identifying content which may be encrypted upon initiation of encoding;
a second step comprising:
encrypting the content based on the one or more encryption keys and;
updating a status indicator;
a third step comprising:
ceasing encryption of the content; and
updating the status indictor.

7. The method of claim 6, wherein the second step further comprises disabling use of a refresh option.

8. The method of claim 6, further comprising archiving the encrypted content to a storage media.

9. The method of claim 6, wherein the first step further comprises posting a key identification to the media management database.

10. The method of claim 6, wherein the method is controlled from a single software application.

11. The method of claim 6, the third step further comprising sending the encrypted content to one or more media servers.

12. A computer program product comprising a computer usable media having computer program logic recorded thereon for establishing, encoding, and distributing digital content comprising:
computer program code logic configured to accept digital content from a content source;
computer program code logic configured to exchange an encryption key with a digital rights management server;
computer program code logic configured to encode and encrypt the digital content based on the encryption key to create encoded and encrypted content;
computer program code logic configured to provide the encoded content to a streaming server and store content onto media storage; and
computer program code logic configured to manage the access to media at a content offerings server wherein the content offerings server provides access to obtain a license to the encoded content.

13. The computer program product of claim 12, wherein the source comprises a signal from a performance or a stored performance.

14. The computer program product of claim 12, wherein the DRM encryption schema is exchanged between encoder, DRM server and database.

15. The computer program product of claim 12, wherein digital rights management server, the streaming server, database and the content offering server are located at the same or different locations and communicate via the Internet.

16. The computer program product of claim 12, further comprising creating a package, wherein the package comprises one or more encoded contents.

17. A method for establishing a connection with a DRM license server and generating encryption information comprising:
accessing security settings within an encoder;
establishing a network location for a DRM license server thereby allowing the encoder to obtain a DRM encryption schema;
creating or selecting a DRM profile, comprising:
sending from the DRM license server at least one of a private key, public certificate, license certificate, root certificate, and seed to the encoder software;
sending from the encoder to the DRM license server at least one of a public key, seed and DRM profile;
applying the DRM profile such that the encoder utilizes the DRM profile for media encryption; and
sending a key ID from the encoder to the database accessed by DRM license server, wherein the key ID can be delivered to provide a license that will unlock the encrypted media created with the encoder.

18. The method of claim 17, wherein the encoder is embodied in machine readable code.

19. The method of claim 17, wherein when the encoder starts encoding, video and audio is converted to compressed encrypted media.

20. The method of claim 18, wherein the encoder is configured to control media access to allow access to media once the media is ready for distribution and all encryption scheme information is available to the DRM license server.
